(19) United States
(12) Patent Application Publication
(10) Pub. No.: US 2007/0186050 A1
(43) Pub. Date: Aug. 9, 2007

(54) Self prefetching L2 cache mechanism for data lines

(75) Inventor: David A. Luick, Rochester, MA (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/347,414

(22) Filed: Feb. 3, 2006

(51) Int. Cl. G06F 12/00

(52) U.S. Cl. 711/137

(57) ABSTRACT

Embodiments of the present invention provide a method and apparatus for prefetching instruction lines. In one embodiment, the method includes fetching a first instruction line from a level 2 cache, extracting, from the first instruction line, an address identifying a first data line containing data targeted by a data access instruction contained in the first instruction line or a different instruction line; and prefetching, from the level 2 cache, the first data line using the extracted address.

### CROSS-REFERENCE TO RELATED APPLICATIONS

This application is related to commonly-owned U.S. patent application entitled “SELF PREFETCHING L2 CACHE MECHANISM FOR INSTRUCTION LINES”, filed on ______ (Atty Docket ROC920050278US1), which is herein incorporated by reference in its entirety.

### BACKGROUND OF THE INVENTION

1. Field of the Invention

The present invention generally relates to the field of computer processors. More particularly, the present invention relates to caching mechanisms utilized by a computer processor.

2. Description of the Related Art

Modern computer systems typically contain several integrated circuits (ICs), including a processor which may be used to process information in the computer system. The data processed by a processor may include computer instructions which are executed by the processor as well as data which is manipulated by the processor using the computer instructions. The computer instructions and data are typically stored in a main memory in the computer system.

Processors typically process instructions by executing the instruction in a series of small steps. In some cases, to increase the number of instructions being processed by the processor (and therefore increase the speed of the processor), the processor may be pipelined. Pipelining refers to providing separate stages in a processor where each stage performs one or more of the small steps necessary to execute an instruction. In some cases, the pipeline (in addition to other circuitry) may be placed in a portion of the processor referred to as the processor core. Some processors may have multiple processor cores.

As an example of executing instructions in a pipeline, when a first instruction is received, a first pipeline stage may process a small part of the instruction. When the first pipeline stage has finished processing the small part of the instruction, a second pipeline stage may begin processing another small part of the first instruction while the first pipeline stage receives and begins processing a small part of a second instruction. Thus, the processor may process two or more instructions at the same time (in parallel).

To provide for faster access to data and instructions as well as better utilization of the processor, the processor may have several caches. A cache is a memory which is typically smaller than the main memory and is typically manufactured on the same die (i.e., chip) as the processor. Modern processors typically have several levels of caches. The fastest cache which is located closest to the core of the processor is referred to as the Level 1 cache (L1 cache). In addition to the L1 cache, the processor typically has a second, larger cache, referred to as the Level 2 Cache (L2 cache). In some cases, the processor may have other, additional cache levels (e.g., an L3 cache and an L4 cache).

To provide the processor with enough instructions to fill each stage of the processor's pipeline, the processor may retrieve instructions from the L2 cache in a group containing multiple instructions, referred to as an instruction line (I-line). The retrieved I-line may be placed in the L1 instruction cache (I-cache) where the core of the processor may access instructions in the I-line. Blocks of data to be processed by the processor may similarly be retrieved from the L2 cache and placed in the L1 cache data cache (D-cache).

The process of retrieving information from higher cache levels and placing the information in lower cache levels may be referred to as fetching, and typically requires a certain amount of time (latency). For instance, if the processor core requests information and the information is not in the L1 cache (referred to as a cache miss), the information may be fetched from the L2 cache. Each cache miss results in additional latency as the next cache/memory level is searched for the requested information. For example, if the requested information is not in the L2 cache, the processor may look for the information in an L3 cache or in main memory.

In some cases, a processor may process instructions and data faster than the instructions and data are retrieved from the caches and/or memory. For example, after an I-line has been processed, it may take time to access the next I-line to be processed (e.g., if there is a cache miss when the L1 cache is searched for the I-line containing the next instruction). While the processor is retrieving the next I-line from higher levels of cache or memory, pipeline stages may finish processing previous instructions and have no instructions left to process (referred to as a pipeline stall). When the pipeline stalls, the processor is underutilized and loses the benefit that a pipelined processor core provides.

Because instructions (and therefore I-lines) are typically processed sequentially, some processors attempt to prevent pipeline stalls by fetching a block of sequentially-addressed I-lines. By fetching a block of sequentially-addressed I-lines, the next I-line may be already available in the L1 cache when needed such that the processor core may readily access the instructions in the next I-line when it finishes processing the instructions in the current I-line.

In some cases, fetching a block of sequentially-addressed I-lines may not prevent a pipeline stall. For instance, some instructions, referred to as exit branch instructions, may cause the processor to branch to an instruction (referred to as a target instruction) outside the block of sequentially-addressed I-lines. Some exit branch instructions may branch to target instructions which are not in the current I-line or in the next, already-fetched, sequentially-addressed I-lines. Thus, the next I-line containing the target instruction of the exit branch may not be available in the L1 cache when the processor determines that the branch is taken. As a result, the pipeline may stall and the processor may operate inefficiently.

With respect to fetching data, where an instruction accesses data, the processor may attempt to locate the data line (D-line) containing the data in the L1 cache. If the D-line cannot be located in the L1 cache, the processor may stall while the L2 cache and higher levels of memory are searched for the desired D-line. Because the address of the desired data may not be known until the instruction is executed, the processor may not be able to search for the desired D-line until the instruction is executed. When the processor does search for the D-line, a cache miss may occur, resulting in a pipeline stall.

Some processors may attempt to prevent such cache misses by fetching a block of D-lines which contain data addresses near (contiguous to) the data address which is currently being accessed. Fetching nearby D-lines relies on the assumption that when a data address in a D-line is accessed, nearby data addresses will likely also be accessed as well (this concept is generally referred to as locality of reference). However, in some cases, the assumption may prove incorrect, such that data in D-lines which are not located near the current D-line are accessed by an instruction, thereby resulting in a cache miss and processor inefficiency.

Accordingly, there is a need for improved methods of retrieving instructions and data in a processor which utilizes cached memory.

### SUMMARY OF THE INVENTION

Embodiments of the present invention provide a method and apparatus for prefetching data lines. In one embodiment, the method includes fetching a first instruction line from a level 2 cache, extracting, from the first instruction line, an address identifying a first data line containing data targeted by a data access instruction contained in the first instruction line or a different instruction line, and prefetching, from the level 2 cache, the first data line using the extracted address.

In one embodiment, a processor is provided. The processor includes a level 2 cache, a level 1 cache, a processor core, and circuitry. The level 1 cache is configured to receive instruction lines from the level 2 cache, wherein each instruction line comprises one or more instructions. The processor core is configured to execute instructions retrieved from the level 1 cache. The circuitry is configured to fetch a first instruction line from a level 2 cache, identify, in the first instruction line, an address identifying a first data line containing data targeted by a data access instruction contained in the first instruction line or a different instruction line, and prefetch, from the level 2 cache, the first data line using the extracted address.

In one embodiment a method of storing data target addresses in an instruction line is provided. The method includes executing one or more instructions in the instruction line, determining if the one or more instructions accesses data in a data line and results in a cache miss, and if so, storing a data target address corresponding to the data line in a location which is accessible by a prefetch mechanism.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a system according to one embodiment of the invention.

FIG. 2 is a block diagram depicting a computer processor according to one embodiment of the invention.

FIG. 3 is a diagram depicting an I-line which accesses a D-line according to one embodiment of the invention.

FIG. 4 is a flow diagram depicting a process for preventing D-cache misses according to one embodiment of the invention.

FIG. 5 is a block diagram depicting an I-line containing a data access address according to one embodiment of the invention.

FIG. 6 is a block diagram depicting circuitry for prefetching instruction and D-lines according to one embodiment of the invention.

FIG. 7 is a block diagram depicting multiple data target addresses for data access instructions in a single I-line being stored in multiple I-lines according to one embodiment of the invention.

FIG. 8 is a flow diagram depicting a process for storing a data target address corresponding to a data access instruction according to one embodiment of the invention.

FIG. 9 is a block diagram depicting a shadow cache for prefetching instruction and D-lines according to one embodiment of the invention.

### DETAILED DESCRIPTION OF THE PREFERRED EMBODIMENTS

Embodiments of the present invention provide a method and apparatus for prefetching D-lines. For some embodiments, an I-line being fetched may be examined for data access instructions (e.g., load or store instructions) that target data in D-lines. The target data address of these data access instructions may be extracted and used to prefetch, from L2 cache, the D-lines containing the targeted data. As a result, if/when the instruction targeting the data is executed, the targeted D-line may already be in the L1 data cache (“D-cache”), thereby, in some cases, avoiding a costly miss in the D-cache and improving overall performance.

For some embodiments, prefetch data (e.g., a targeted address) may be stored in a traditional cache memory in the corresponding block of information (e.g. appended to an I-line or D-line) to which the prefetch data pertains. For example, as the corresponding line of information is fetched from the cache memory, the prefetch data contained therein may be examined and used to prefetch other, related lines of information. Similar prefetches may then be performed using prefetch data stored in each other prefetched line of information. By using information within a fetched I-line to prefetch D-lines containing data targeted by instructions in the I-line, cache misses associated with the fetched block of information may be prevented.

According to one embodiment of the invention, storing prefetch data in a cache as part of an I-line may obviate the need for special caches or memories which exclusively store prefetch and prediction data. However, as described below, in some cases, such information may be stored in any location, including special caches or memories devoted to storing such history information. Also, in some cases, a combination of different caches (and cache lines), buffers, special-purpose caches, and other locations may be used to store history information described herein.

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

Embodiments of the invention may be utilized with and are described below with respect to a system, e.g., a computer system. As used herein, a system may include any system utilizing a processor and a cache memory, including a personal computer, internet appliance, digital media appliance, portable digital assistant (PDA), portable music/video player and video game console. While cache memories may be located on the same die as the processor which utilizes the cache memory, in some cases, the processor and cache memories may be located on different dies (e.g., separate chips within separate modules or separate chips within a single module).

While described below with respect to a processor having multiple processor cores and multiple L1 caches, wherein each processor core uses a pipeline to execute instructions, embodiments of the invention may be utilized with any processor which utilizes a cache, including processors which have a single processing core and/or processors which do not utilize a pipeline in executing instructions. In general, embodiments of the invention may be utilized with any processor and are not limited to any specific configuration.

While described below with respect to a processor having an L1-cache divided into an L1 instruction cache (L1 I-cache, or I-cache) and an L1 data cache (L1 D-cache, or D-cache 224), embodiments of the invention may be utilized in configurations wherein a unified L1 cache is utilized. Furthermore, while described below with respect to prefetching I-lines and D-lines from an L2 cache and placing the prefetched lines into an L1 cache, embodiments of the invention may be utilized to prefetch I-lines and D-lines from any cache or memory level into any other cache or memory level.

### Overview of an Exemplary System

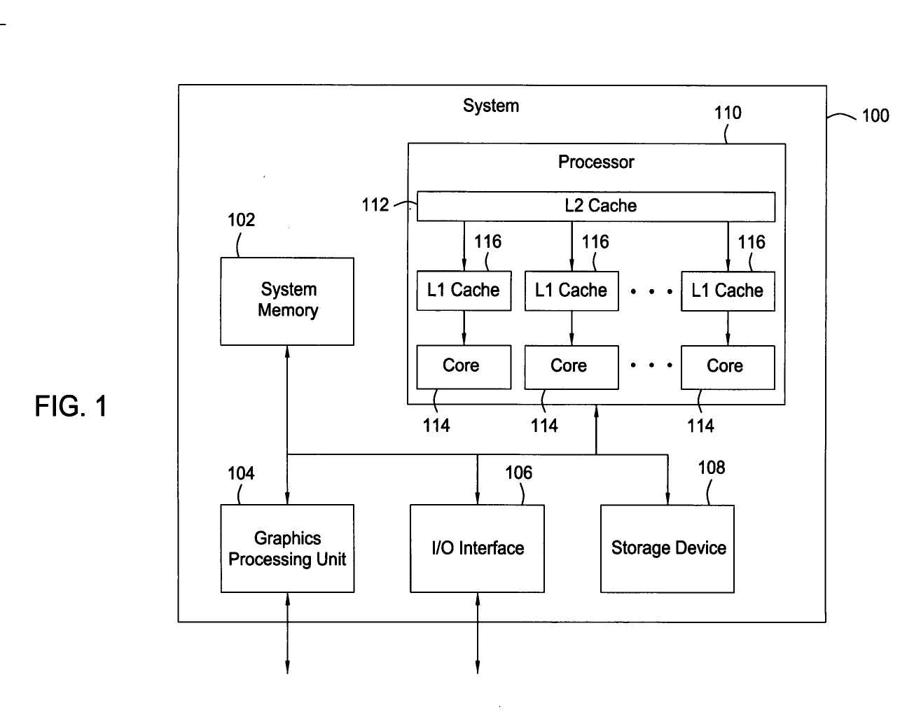

FIG. 1 is a block diagram depicting a system 100 according to one embodiment of the invention. The system 100 may contain a system memory 102 for storing instructions and data, a graphics processing unit 104 for graphics processing, an I/O interface for communicating with external devices, a storage device 108 for long term storage of instructions and data, and a processor 110 for processing instructions and data.

According to one embodiment of the invention, the processor 110 may have an L2 cache 112 as well as multiple L1 caches 116, with each L1 cache 116 being utilized by one of multiple processor cores 114. According to one embodiment, each processor core 114 may be pipelined, wherein each instruction is performed in a series of small steps with each step being performed by a different pipeline stage.

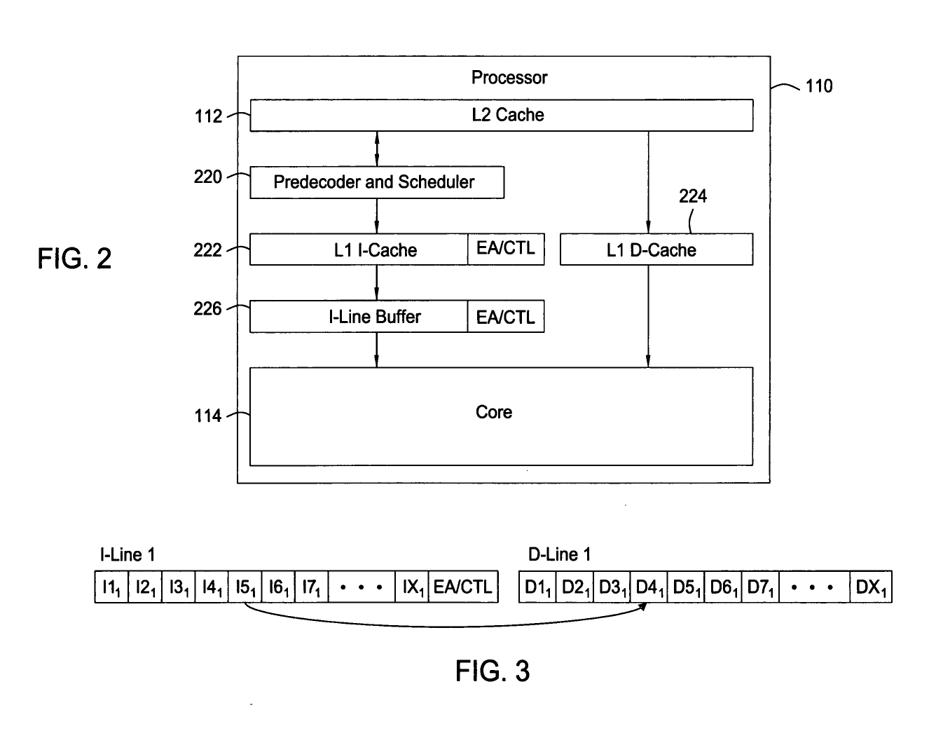

FIG. 2 is a block diagram depicting a processor 110 according to one embodiment of the invention. For simplicity, FIG. 2 depicts and is described with respect to a single core 114 of the processor 110. In one embodiment, each core 114 may be identical (e.g., contain identical pipelines with identical pipeline stages). In another embodiment, each core 114 may be different (e.g., contain different pipelines with different stages).

In one embodiment of the invention, the L2 cache may contain a portion of the instructions and data being used by the processor 110. In some cases, the processor 110 may request instructions and data which are not contained in the L2 cache 112. Where requested instructions and data are not contained in the L2 cache 112, the requested instructions and data may be retrieved (either from a higher level cache or system memory 102) and placed in the L2 cache. When the processor core 114 requests instructions from the L2 cache 112, the instructions may be first processed by a predecoder and scheduler 220 (described below in greater detail).

In one embodiment of the invention, the L1 cache 116 depicted in FIG. 1 may be divided into two parts, an L1 instruction cache 222 (L1 I-cache 222) for storing I-lines as well as an L1 data cache 224 (L1 D-cache) for storing D-lines. After I-lines retrieved from the L2 cache 112 are processed by a predecoder and scheduler 220, the I-lines may be placed in the I-cache 222. Similarly, D-lines fetched from the L2 cache 112 may be placed in the D-cache 224. A bit in each I-line and D-line may be used to track whether a line of information in the L2 cache 112 is an I-line or D-line.

In one embodiment of the invention, instructions may be fetched from the L2 cache 112 and the I-cache 222 in groups, referred to as I-lines and placed in an I-line buffer 226 where the processor core 114 may access the instructions in the I-line. Similarly, data may be fetched from the L2 cache 112 and D-cache 224 in groups referred to as D-lines. In one embodiment, a portion of the I-cache 222 and the I-line buffer 226 may be used to store effective addresses and controls bits (EA/CTL) which may be used by the core 114 and/or the predecoder and scheduler 220 to process each I-line, for example, to implement the data prefetching mechanism described below.

### Prefetching D-Lines from the L2 Cashe

FIG. 3 is a diagram depicting an exemplary I-line containing a data access instruction (15₁) which targets data (D4₁) in a D-line, according to one embodiment of the invention. In one embodiment, the I-line (I-line 1) may contain a plurality of instructions (e.g., I1₁, I2₁, I3₁, etc.) as well as control information such as effective addresses and control bits. Similarly, the D-line (D-line 1) may contain a plurality of data words (e.g., D1₁, D2₁, D3₁, etc.). In some degree, the instructions in each I-line may be executed in order, such that instruction I1₁ is executed first, I2₁ is executed second, and so on. Because the instructions are executed in order, I-lines are also typically executed in order. Thus, in some cases, each time an I-line is moved from the L2 cache 112 to the I-cache 222, the pre-decoder and scheduler 220 may examine the I-line (e.g., I-Line 1) and prefetch the next sequential I-line (e.g., I-line 2) so that the next I-line is placed in the I-cache 222 and accessible by the processor core 114.

In some cases, an I-line being executed by the processor core 114 may include data access instructions (e.g., load or store instructions) such as instruction 15₁. A data access instruction targets data at an address (e.g., D4₁) to perform an operation (e.g., a load or a store). In some cases, the data access instruction may request the data address as an offset from some other address (e.g., an address stored in a data register), such that the data address is calculated when the data access instruction is executed.

When instruction 15₁ is executed by the processor core 114, the processor core 114 may determine that data D4₁ is accessed by the instruction. The processor core 114 may attempt to fetch the D-line (D-line 1) containing data D4₁ from the D-cache 224. In some cases, D-line 1 may not be present in the D-cache 224, thereby causing a cache miss. When the cache miss is detected in the D-cache, a fetch request for D-Line 1 may be issued to the L2 cache 112. In some cases, while the fetch request is being processed by the L2 cache 112, the processor pipeline in the core 114 may stall, thereby halting the processing of instructions by the processor core 114. If D-line 1 is not in the L2 cache 112, the processor pipeline may stall for a longer period while the D-line is fetched from higher cache and/or memory levels.

According to one embodiment of the invention, the number of D-cache misses may be reduced by prefetching a D-line according to a data target address extracted from an I-line currently being fetched.

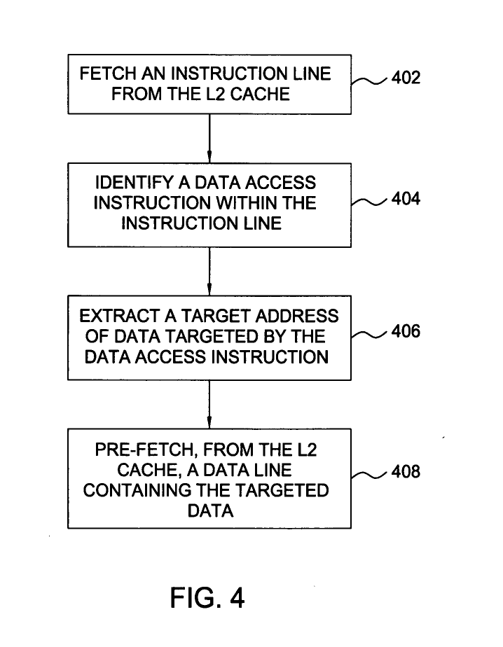

FIG. 4 is a flow diagram depicting a process 400 for reducing or preventing D-cache misses according to one embodiment of the invention. The process 400 may begin at step 404 where an I-line is fetched from the L2 cache 112. At step 406, a data access instruction may be identified, and at step 408 an address of data targeted by the data access instruction (referred to as the data target address) may be extracted. Then, at step 410, a D-line containing the targeted data may be prefetched from the L2 cache 112 using the data target address. By prefetching the D-line containing the targeted data and placing the prefetched data in the D-cache 224, a cache miss may thereby be prevented if/when the data access instruction is executed. In some cases, the data target address may only be stored if there is, in fact, a D-cache miss or history of a D-cache miss.

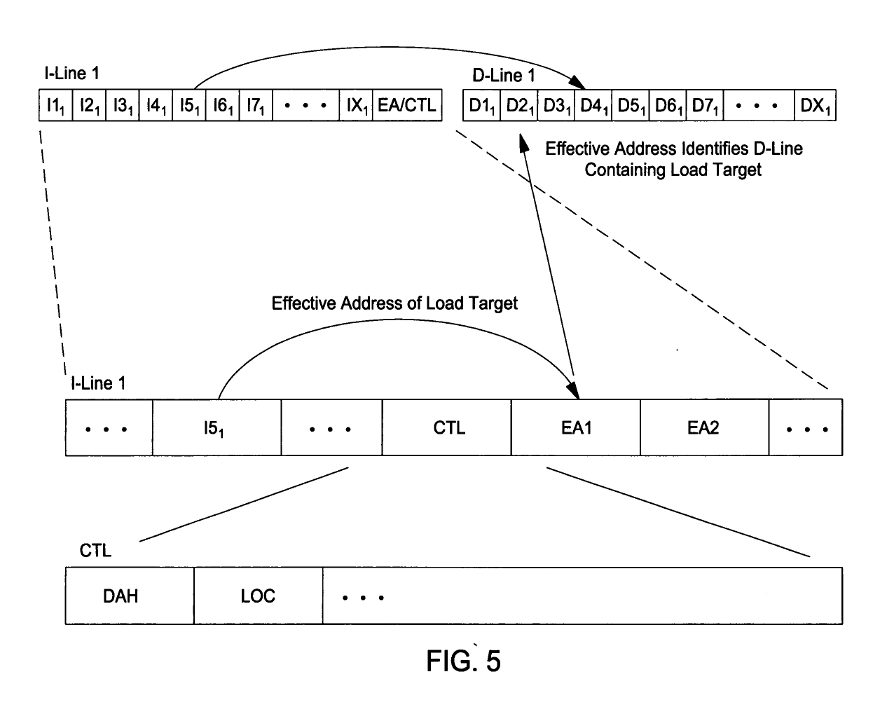

In one embodiment, the data target address may be stored directly in (appended to) an I-line as depicted in FIG. 5. The stored data target address EA1 may be an effective address or a portion of an effective address (e.g., a high order 32 bits of the effective address). As depicted, the data target address EA1 may identify a D-line containing the address of data D4, targeted by data access instruction 15₁.

According to one embodiment, the I-line may also store other effective addresses (e.g., EA2) and control bits (e.g., CTL). As described below, the other effective addresses may be used to prefetch I-lines containing instructions targeted by branch instructions in the I-line or additional D-lines. The control bits CTL may include one or more bits which indicate the history of a data access instruction (DAH) as well as the location of the data access instruction (LOC). Use of such information stored in the I-line is also described below.

In one embodiment of the invention, effective address bits and control bits described herein may be stored in otherwise unused bits of the I-line. For example, each information line in the L2 cache 112 may have extra data bits which may be used for error correction of data transferred between different cache levels (e.g., an error correction code, ECC, used to ensure that transferred data is not corrupted and to repair any corruption which does occur). In some cases, each level of cache (e.g., the L2 cache 112 and the I-cache 222) may contain an identical copy of each I-line. Where each level of cache contains a copy of a given I-line, an ECC may not be utilized. Instead, for example, a parity bit may used, for example, to determine if an I-line was properly transferred between caches. If the parity bit indicates that an I-line is improperly transferred between caches, the I-line may be refetched from the transferring cache (because the cache is inclusive of the line) instead of performing error checking.

As an example of storing addresses and control information in otherwise unused bits of an I-line, consider an error correction protocol which uses eleven bits for error correction for every two words stored. In an I-line, one of the eleven bits may be used to store a parity bit for every two instructions (where one instruction is stored per word). The remaining five bits per instruction may be used to store control bits for each instruction and/or address bits. For example, four of the five bits may be used to store control bits (such as history bits) for the instruction, such as history information about the instruction (e.g., whether the instruction is a branch instruction which was previously taken, or whether the instruction is a data access instruction which previously caused a D-cache miss). If the I-line includes 32 instructions, the remaining 32 bits (one bit for each instruction) may be used to store, for example all or a portion of a data target address or branch exit address.

### Exemplary Prefetch Circuitry

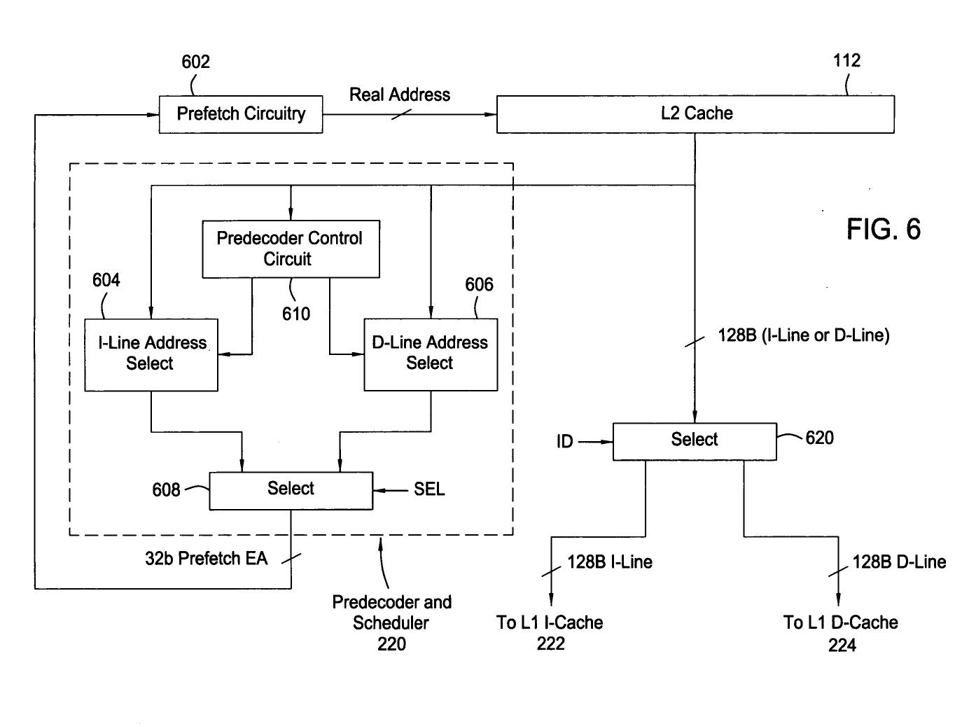

FIG. 6 is a block diagram depicting circuitry for prefetching instruction and D-lines according to one embodiment of the invention. In one embodiment of the invention, the circuitry may prefetch only D-lines. In another embodiment of the invention, the circuitry may prefetch both I-lines and D-lines.

Each time an I-line or D-line is fetched from the L2 Cache 112 to be placed in the I-cache 222 or D-cache 224, respectively, select circuitry 620 controlled by an instruction/data (I/D) may route the fetched I-Line or D-line to the appropriate cache.

The predecoder and scheduler 220 may examine information being output by the L2 cache 112. In one embodiment, where multiple processor cores 114 are utilized, a single predecoder and scheduler 220 may be shared between multiple processor cores. In another embodiment, a predecoder and scheduler 220 may by provided separately for each processor core 114.

In one embodiment, the predecoder and scheduler 220 may have a predecoder control circuit 610 which determines if information being output by the L2 cache 112 is an I-line or D-line. For instance, the L2 cache 112 may set a specified bit in each block of information contained in the L2 cache 112 and the predecoder control circuit 610 may examine the specified bit to determine if a block of information output by the L2 cache 112 is an I-line or D-line.

If the predecoder control circuit 610 determines that the information output by the L2 cache 112 is an I-line, the predecoder control circuit 610 may use an I-line address select circuit 604 and a D-line address select circuit 606 to select any appropriate effective addresses (e.g., EA1 or EA2) contained in the I-line. The effective addresses may then be selected by select circuit 608 using the select (SEL) signal. The selected effective address may then be output to prefetch circuitry 602, for example, as a 32 bit prefetch address for use in prefetching the corresponding I-line or D-line from the L2 cache 112.

As described above, a data target address in a first I-line may be used to prefetch a first D-line. In some cases, a first fetched I-line may also contain a branch instruction which branches to a target instruction in a second I-line (referred to as an exit branch instruction). In one embodiment, an address (referred to as an exit address) corresponding to the second I-line may also be stored in the first fetched I-line. When the first I-line is fetched, the stored exit address may be used to prefetch the second I-line. Prefetching of I-lines is described in the commonly-owned U.S. patent application entitled “SELF PREFETCHING L2 CACHE MECHANISM FOR INSTRUCTION LINES”, filed on (Atty Docket ROC920050278US1), which is hereby incorporated by reference in its entirety. By prefetching the second I-line, an I-cache miss may be avoided if the branch in the first I-line is followed and the target instruction in the second I-line is requested from the I-cache.

Thus, in some cases, a group (chain) of I-lines and D-lines may be prefetched into the I-cache 222 and D-cache 224 based on a single I-line being fetched, thereby reducing the chance that exit branch instructions or data access instructions in a fetched or prefetched I-line will cause an I-cache miss or D-cache miss.

When the second I-line indicated by the exit address is prefetched from the L2 cache 112, in some cases the second I-line may be examined to determine if the second I-line contains a data target address corresponding a second D-line accessed by a data access instruction within the second I-line. Where a prefetched I-line contains a data target address corresponding to a second D-line, the second D-line may also be prefetched.

In one embodiment, the prefetched second I-line may contain an effective address of a third I-line which may also be prefetched. Again, the third I-line may also contain an effective address of a target D-line which may be prefetched. The process of prefetching I-lines and corresponding D-lines may be repeated. Each prefetched I-line may contain effective addresses for both multiple I-lines and/or multiple D-lines to be prefetched from main memory.

As an example, in one embodiment, the D-cache 224 may be a two port cache such that two D-lines may be fetched from the L2 caches 112 and placed in the two port D-cache 224 at the same time. Where such a configuration is used, two effective addresses corresponding to two D-lines may be stored in each I-line, and if the I-line is fetched from the L2 cache 112, both D-lines may, in some cases, be simultaneously prefetched from the L2 cache 112 using the effective addresses and placed into the D-cache 224, possibly avoiding a D-cache miss.

Thus, in some cases, a group (chain) of I-lines and D-lines may be prefetched into the I-cache 222 and D-cache 224 based on a single I-line being fetched, thereby reducing the chance that exit branch instructions or data access instructions in a fetched or prefetched I-line will cause an I-cache miss or D-cache miss.

According to one embodiment, where a prefetched I-line contains multiple effective addresses to be prefetched, the addresses may be temporarily stored (e.g., in the predecoder control circuit 610 or the I-Line address select circuit 604, or some other buffer) while each effective address is sent to the prefetch circuitry 602. In another embodiment, the prefetch address may be sent in parallel to the prefetch circuitry 602 and/or the L2 cache 112.

The prefetch circuitry 602 may determine if the requested effective address is in the L2 cache 112. For example, the prefetch circuitry 602 may contain a content addressable memory (CAM), such as a translation look-aside buffer (TLB) which may determine if a requested effective address is in the L2 cache 112. If the requested effective address is in the L2 cache 112, the prefetch circuitry 602 may issue a request to the L2 cache to fetch a real address corresponding to the requested effect address. The block of information corresponding to the real address may then be output to the select circuit 620 and directed to the appropriate L1 cache (e.g., the I-cache 222 or the D-cache 224). If the prefetch circuitry 602 determines that the requested effective address is not in the L2 cache 112, then the prefetch circuitry may send a signal to higher levels of cache and/or memory. For example, the prefetch circuitry 602 may send a prefetch request for the address to an L3 cache which may then be searched for the requested address.

In some cases, before the predecoder and scheduler 220 attempts to prefetch an I-line or D-line from the L2 cache 112, the predecoder and scheduler 220 (or, optionally, the prefetch circuitry 602) may determine if the requested I-line or D-line being prefetched is already contained in either the I-cache 222 or the D-cache 224, or if a prefetch request for the requested I-line or D-line has already been issued. For example, a small cache containing a history of recently fetched or prefetched I-line or D-line addresses may be used to determine if a prefetch request has already been issued for an I-line or D-line or if a requested I-line or D-line is already in the I-cache 222 or the D-cache 224.

If the requested I-line or D-line is already located in the I-cache 222 or the D-cache 224, an L2 cache prefetch may be unnecessary and may therefore not be performed. In some cases, where a second prefetch request is rendered unnecessary by previous prefetch request, storing the current effective address in the I-line may also be unnecessary, allowing other effective addresses to be stored in the I-line (described below).

In one embodiment of the invention, the predecoder and scheduler 220 may continue prefetching I-lines (and D-lines) until a threshold number of I-lines and/or D-lines has been fetched. The threshold may be selected in any appropriate manner. For example, the threshold may be selected based upon the number of I-lines and/or D-lines which may be placed in the I-cache and D-cache respectively. A large threshold number of prefetches may be selected where the I-cache and/or the D-cache have a larger capacity whereas a small threshold number of prefetches may be selected where the I-cache and/or D-cache have a smaller capacity.

As another example, the threshold number of I-line prefetches may be selected based on the predictability of conditional branch instructions within the I-lines being fetched. In some cases, the outcome of the conditional branch instructions may be predictable (e.g., whether the branch is taken or not), and thus, the proper I-line to prefetch may be predictable. However, as the number of branch predictions between I-lines increases, the overall accuracy of the predictions may become small such that there may be a small chance a given I-line will be accessed. The level of unpredictability may increase as the number of prefetches which utilize unpredictable branch instructions increases. Accordingly, in one embodiment, a threshold number of I-line prefetches may be chosen such that the predicted likelihood of accessing a prefetched I-line does not fall below a given percentage. Also, in some cases, where an unpredictable branch is reached (e.g., a branch where a predictability value for the branch is below a threshold for predictability), I-lines may be fetched for both paths of the branch instruction (e.g., for both the predicted branch path and the unpredicted branch path).

As another example, a threshold number of D-line prefetches may be performed based on the predictability of a data accesses within a fetched D-line. In one embodiment, D-line prefetches may be issued for D-lines containing data targeted by data access instructions which, when previously executed, resulted in a D-cache miss. Predictability data also may be stored for data access instructions which cause D-cache misses. Where predictability data is stored, a threshold number of prefetches may be performed based upon the relative predictability of a D-cache miss occurring for the D-line being prefetched.

In some cases, the chosen threshold for I-line and D-line prefetches may be a fixed number selected according to a test run of sample instructions. In some cases, the test run and selection of the threshold may be performed at design time and the threshold may be pre-programmed into the processor 110. Optionally, the test run may occur during an initial “training” phase of program execution (described below in greater detail). In another embodiment, the processor 110 may track the number of prefetched I-lines and D-lines containing unpredictable branch instructions and/or unpredictable data accesses and stop prefetching I-lines and D-lines only after a given number of I-lines and D-lines containing unpredictable branch instructions or unpredictable data access instructions have been prefetched, such that the threshold number of prefetched I-lines varies dynamically based on the execution history of the I-lines.

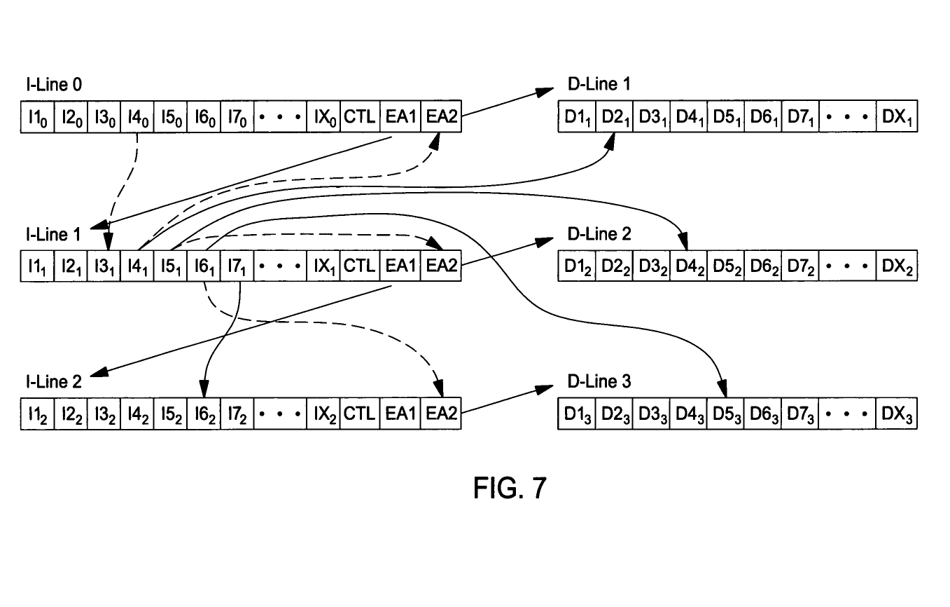

In one embodiment of the invention, data target addresses for an instruction in an I-line may be stored in a different I-line. FIG. 7 is a block diagram depicting multiple data target addresses for data access instructions in a single I-line being stored in multiple I-lines according to one embodiment of the invention. As depicted, I-line 1 may contain three data access instructions (I4₁, I5₁, I6₁) which access data target addresses D2₁, D4₂, D5₃ in three separate D-lines (D-line 1, D-line 2, D-line 3, depicted by curved, solid lines). In one embodiment of the invention, addresses corresponding to the target address of one or more of the data access instructions may be stored in an I-line (I-line 0 or I-line 2) which is adjacent in a fetching sequence with the source I-line (I-line 1).

When data access instructions I4₁, I5₁, I6₁, are detected in I-line 1 (as described below), data target addresses corresponding to D-line 1, D-line 2, and D-line 3 may be also be stored in I-line 0, I-line 1, and I-line 2 in location EA2, respectively (depicted by curved, dashed lines). In some cases, in order to track the accesses by the data access instructions I4₁, I5₁, I6₁ to the target data target addresses D2_{1, D4}₂, D5₃, location information indicating the source of the data target information (e.g., I-line 1) may be stored in each I-line, for example, in the location (LOC) control bits appended to the I-line.

Thus, effective addresses for D-line 1 and I-line 1 may be stored in I-line 0, effective addresses for I-line 2 and D-line 2 may be stored in I-line 1, and an effective address for D-line 3 may be stored in I-line 2. When I-line 0 is fetched, I-line 1 and I-line 2 may be prefetched using the effective addresses stored in I-line 0 and I-line 1, respectively. While I-line 0 may not contain a data access instruction which accesses D-line 1, D-line 1 may be prefetched using the effective address stored in I-line 0 such that a D-cache miss may be avoided if/when instruction 14₁ in I-line 2 attempts to access data D2₁ in D-line 1. D-lines D-line 2 and D-line 3 may similarly be prefetched when I-lines 1 and 2 are prefetched, so that D-cache misses may be avoided if/when instructions I5₁ and I6₁ in I-line 1 attempts to access data locations D4₂ and D5₃, respectively.

Storing data target addresses for an instruction in an I-line in a different I-line may be useful in some cases where not every I-line contains a data target address which is stored. For example, where data target addresses are stored when accessing the data at the target address causes a D-cache miss, one I-line may contain several data access instructions (for example, three instructions) which cause D-cache misses while other I-lines may not contain any data access instruction which causes a D-cache miss. Accordingly, one or more of the data target addresses for the data access instructions causing D-cache misses in the one I-line may be stored in other I-lines, thereby spreading storage of the data target addresses to the other I-lines (for example, two of the three data target addresses may be stored in two other I-lines, respectively).

### Storing a D-Line Prefetch Address for an I-Line

According to one embodiment of the invention, data target addresses of a data access instruction may be extracted and stored in an I-line when executing the data access instruction and requesting the D-line containing the data target address leads to a D-cache miss.

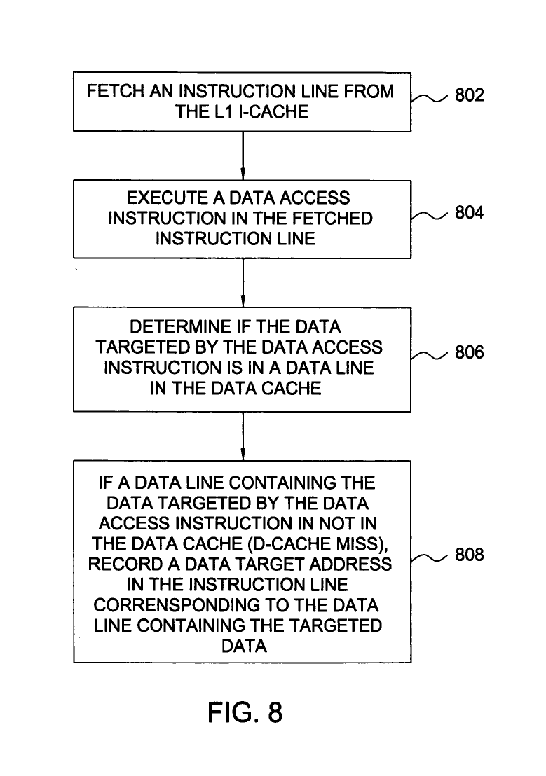

FIG. 8 is a flow diagram depicting a process 800 for storing a data target address corresponding to a data access instruction according to one embodiment of the invention. The process 800 may begin at step 802 where an I-line is fetched, for example, from the I-cache 222. At step 804 a data access instruction in the fetched I-line may be executed. At step 806, a determination may be made of whether a D-line containing the data targeted by the data access instruction is located in the D-cache 224. At step 808, if the D-line containing the data targeted by the data access instruction is not in the D-cache 224, the effective address of the targeted data is stored as the data target address. By recording the data target address corresponding to the targeted data, the next time the I-line is fetched from the L2 cache 112, the D-line containing the targeted data may be prefetched from the L2 cache 112. By prefetching the D-line, a data cache miss which might otherwise occur if/when the data access instruction is executed may, in some cases, be prevented.

As another option, the data target addresses for data access instructions may be determined at execution time and stored in the I-line regardless of whether the data access instructions causes a D-cache miss. For example, a data target address for each data access instruction may be extracted and stored in the I-line. Optionally, a data target address for the most frequently executed data access instruction(s) may be extracted and stored in the I-line. Other manners of determining and storing data target addresses are discussed in greater detail below.

In one embodiment of the invention, the data target address may not be calculated until a data access instruction which accesses the data target address is executed. For instance, the data access instruction may specify an offset value from an address stored in an address register from which the data access should be made. When the data access instruction is executed, the effective address of the target data may be calculated and stored as the data target address. In some cases, the entire effective address may be stored. However, in other cases, only a portion of the effective address may be stored. For instance, if a cached D-line containing the target data of the data access instruction may be located using only the higher-order 32 bits of an effective address, then only those 32 bits may be saved as the data target address for purposes of prefetching the D-line.

In another embodiment of the invention, data target addresses may be determined without executing data access instructions. For example, the data target addresses may be extracted from the data access instructions in a fetched D-line as the D-line is fetched from the L2 cache 112.

### Tracking and Recording D-Line Access History

In one embodiment of the invention, various amounts of data access history information may be stored. In some cases, the data access history may indicate which data access instructions in an I-line will (or are likely to) be executed. Optionally, the data access history may indicate which data access instructions will cause (or have caused) a D-cache miss. Which data target address or addresses are stored in an I-line (and/or which D-lines are prefetched) may be determined based upon the stored data access history information generated during real-time execution or during a pre-execution “training” period.

According to one embodiment, as described above, only the data target address corresponding to the most recently executed data access instruction in an I-line may be stored. Storing the data target address corresponding to the most recently accessed data in an I-line effectively predicts that the same data will be accessed when the I-line is subsequently fetched. Thus, the D-line containing the target data for the previously executed data access instruction may be prefetched.

In some cases, one or more bits may be used to record the history of data access instructions. The bits may be used to determine which D-lines are accessed most frequently or which D-lines, when accessed, cause D-cache misses. For example, as depicted in FIG. 5, the control bits CTL stored in the I-line (I-line 1) may contain information which indicates which data access instruction in the I-line was previously executed or previously caused a D-cache miss (LOC). The I-line may also contain a history of when the data access instruction was executed or caused a cache miss (DAH) (e.g., how many times within a monitored number of executions that instruction was executed or caused a cache miss in some number of previous executions).

As an example of how the data access instruction location LOC and data access history DAH may be used, consider an I-line in the L2 cache 112 which has not been fetched to the L1 cache 222. When the I-line is fetched to the L1 cache 222, the predecoder and scheduler 220 may initially determine that that I-line has no data target address and may accordingly not prefetch another D-line.

As instructions in the fetched I-line are executed during training, the processor core 114 may determine whether a data access instruction within the I-line is being executed. If a data access instruction is detected, the location of the data access instruction within the I-line may be stored in LOC in addition to storing the data target address in EA1. If each I-line contains 32 instructions, LOC may be a five-bit binary number such that the numbers 0-31 (corresponding to each possible instruction location) may be stored in LOC to indicate the exit branch instruction. Optionally, where LOC indicates a source instruction and a source I-line (as described above with respect to storing effective addresses for a single I-line in multiple I-lines), LOC may contain additional bits to indicate both a location within an I-line as well as which adjacent I-line the data access instruction is located in.

In one embodiment, a value may also be written to DAH which indicates that the data access instruction located at LOC was executed or caused a D-cache miss. For example, if DAH is a single bit, during the first execution of the instructions in the I-line, when a data access instruction is executed, a 0 may be written to DAH for the instruction. The 0 stored in DAH may indicate a weak prediction that the data access instruction located at LOC will be executed during a subsequent execution of instructions contained in the I-line. Optionally, the 0 stored in DAH may indicate a weak prediction that the data access instruction located at LOC will cause a D-cache miss during a subsequent execution of instructions contained in the I-line.

If, during a subsequent execution of instructions in the I-line, the data access instruction located at LOC is executed (or causes a D-cache miss) again, DAH may be set to 1. The 1 stored in DAH may indicate a strong prediction that the data access instruction located at LOC will be executed again or cause a D-cache miss again.

If, however, the same I-line (DAH=1) is fetched again and a different exit branch instruction is taken, the values of LOC and EA1 may remain the same, but DAH may be cleared to a 0, indicating a weak prediction that the previously taken branch will be taken during a subsequent execution of the instructions contained in the I-line.

Where DAH is 0 (indicating a weak prediction) and a data access instruction other than the data access instruction indicated by LOC is executed (or is executed and causes a D-cache miss), the data target address EA1 may be overwritten with the data target address of the data access instruction and LOC may be changed to a value corresponding to the executed data access instruction (or the data access instruction causing a D-cache miss) in the I-line.

Thus, where data access history bits are utilized, the I-line may contain a stored data target address which corresponds to a data target address. Such regularly executed data access instructions or access instructions which cause D-cache misses may be preferred over data access instructions which are infrequently executed or infrequently cause D-cache misses. If, however, the data access instruction is weakly predicted and another data access instruction is executed or causes a D-cache miss, the data target address may be changed to the address corresponding to the data access instruction, such that weakly predicted data access instructions are not preferred when other data access instructions are regularly being executed or optionally, regularly causing cache misses.

In one embodiment, DAH may contain multiple history bits so that a longer history of the data access instruction indicated by LOC may be stored. For instance, if DAH is two binary bits, 00 may correspond to a very weak prediction (in which case executing other data access instructions or determining that other data access instructions cause a D-cache miss will overwrite the data target address and LOC) whereas 01, 10, and 11 may correspond to weak, strong, and very strong predictions, respectively (in which case executing other data access instructions or detecting other D-cache misses may not overwrite the data target address or LOC). As an example, to replace a data target address corresponding to a strongly predicted D-cache miss, the processor configuration 100 may require that three other data access instruction cause a D-cache miss on three consecutive executions of instructions in the I-line.

Furthermore, in one embodiment, a D-line corresponding to a data target address may, in some cases, only be prefetched where the DAH bits indicate that a D-cache miss (e.g., when the processor core 114 attempts to access the D-line) is very strongly predicted. Optionally, a different level of predictability (e.g., strong predictability as opposed to very strong predictability) may be selected as a prerequisite for prefetching a D-line.

In one embodiment of the invention, multiple data access histories (e.g., DAH1, DAH2, etc.), multiple data access instruction locations (e.g., LOC1, LOC2, etc.), and/or multiple effective addresses may be utilized. For example, in one embodiment, multiple data access histories may be tracked using DAH1, DAH2, etc., but only one data target address, corresponding to the most predictable data access and/or predicted D-cache miss out of DAH1, DAH2, etc., may be stored in EA1. Optionally, multiple data access histories and multiple data target addresses may be stored in a single I-line. In one embodiment, the data target addresses may be used to prefetch D-lines only where the data access history indicates that a given data access instruction designated by LOC is predictable (e.g., will be executed and/or cause a D-cache miss). Optionally, only D-lines corresponding to the most predictable data target address out of several stored addresses may be prefetched by the predecoder and scheduler 220.

As previously described, in one embodiment of the invention, whether a data access instruction causes a D-cache miss may be used to determine whether or not to store a data target address. For example, if a given data access instruction rarely causes a D-cache miss, a data target address corresponding to the data access instruction may not be stored, even though the data access instruction may be executed more frequently than other data access instructions in the I-line. If another data access instruction in the I-line is executed less frequently but generally causes more D-cache misses, then a data target address corresponding to the other data access instruction may be stored in the I-line. History bits, such as one or more D-cache “miss” flags, may be used as described above to determine which data access instruction is most likely to cause a D-cache miss.

In some cases, a bit stored in the I-line may be used to indicate whether a D-line is placed in the D-cache 224 because of a D-cache miss or because of a prefetch. The bit may be used by the processor 110 to determine the effectiveness of a prefetch in preventing a cache miss. In some cases, the predecoder and scheduler 220 (or optionally, the prefetch circuitry 602) may also determine that prefetches are unnecessary and change bits in the I-line accordingly. Where a prefetch is unnecessary, e.g., because the information being prefetched in already in the I-cache 222 or D-cache 224, other data target addresses corresponding to access instructions which cause more I-cache and D-cache misses may be stored in the I-line.

In one embodiment, whether a data access instruction causes a D-cache miss may be the only factor used to determine whether or not to store a data target address for a data access instruction. In another embodiment, both the predictability of executing a data access instruction and the predictability of whether the data access instruction will cause a D-cache miss may be used together to determine whether or not to store a data target address. For example, values corresponding to the access history and miss history may be added, multiplied, or used in some other formula (e.g., as weights) to determine whether or not to store a data target address and/or prefetch a D-line corresponding to the data target address.

In one embodiment of the invention, the data target address, data access history, and data access instruction location may be continuously tracked and updated at runtime such that the data target address and other values stored in the I-line may change over time as a given set of instructions is executed. Thus, the data target address and the prefetched D-lines may be dynamically modified, for example, as a program is executed.

In another embodiment of the invention, the data target address may be selected and stored during an initial execution phase of a set of instructions (e.g., during an initial “training” period in which a program is executed). The initial execution phase may also be referred to as an initialization phase or a training phase. During the training phase, data access histories and data target addresses may be tracked and one or more data target addresses may be stored in the I-line (e.g., according to the criteria described above). When the phase is completed, the stored data target addresses may continue to be used to prefetch D-lines from the L2 cache 112, however, the data target address(es) in the fetched I-line may no longer be tracked and updated.

In one embodiment, one or more bits in the I-line containing the data target address(es) may be used to indicate whether the data target address is being updated during the initial execution phase. For example, a bit may be cleared during the training phase. While the bit is cleared, the data access history may be tracked and the data target address(es) may be updated as instructions in the I-line are executed. When the training phase is completed, the bit may be set. When the bit is set, the data target address(es) may no longer be updated and the initial execution phase may be complete.

In one embodiment, the initial execution phase may continue for a specified period of time (e.g., until a number of clock cycles has elapsed). In one embodiment, the most recently stored data target address may remain stored in the I-line when the specified period of time elapses and the initial execution phase is exited. In another embodiment, a data target address corresponding to the most frequently executed data access instruction or corresponding to the data access instruction causing the most frequent number of D-cache misses may be stored in the I-line and used for subsequent prefetching.

In another embodiment of the invention, the initial execution phase may continue until one or more exit criteria are satisfied. For example, where data access histories are stored, the initial execution phase may continue until one of the data access instructions in an I-line becomes predictable (or strongly predictable) or until a D-cache miss becomes predictable (or strongly predictable). When a given data access instruction becomes predictable, a lock bit may be set in the I-line indicating that the initial training phase is complete and that the data target address for the strongly predictable data access instruction may be used for each subsequent D-line prefetch performed when the I-line is fetched from the L2 cache 112.

In another embodiment of the invention, the data target addresses in an I-line may be modified in intermittent training phases. For example, a frequency and duration value for each training phase may be stored. Each time a number of clock cycles corresponding to the frequency has elapsed, a training phase may be initiated and may continue for the specified duration value. In another embodiment, each time a number of clock cycles corresponding to the frequency has elapsed, the training phase may be initiated and continue until specified conditions are satisfied (for example, until a specified level of data access or cache miss predictability for an instruction is reached, as described above).

In one embodiment of the invention, each level of cache and/or memory used in the system 100 may contain a copy of the information contained in an I-line. In another embodiment of the invention, only specified levels of cache and/or memory may contain the information (e.g., data access histories and data target addresses) contained in the I-line. In one embodiment, cache coherency principles, known to those skilled in the art, may be used to update copies of the I-line in each level of cache and/or memory.

It is noted that in traditional systems which utilize instruction caches, instructions are typically not modified by the processor 110. Thus, in traditional systems, I-lines are typically aged out of the I-cache 222 after some time instead of being written back to the L2 cache 112. However, as described herein, in some embodiments, modified I-lines may be written back to the L2 cache 112, thereby allowing the prefetch data to be maintained at higher cache and/or memory levels.

As an example, when instructions in an I-line have been processed by the processor core (possible causing the data target address and other history information to be updated), the I-line may be written into the I-cache 222 (referred to as a write-back), possibly overwriting an older version of the I-line stored in the I-cache 222. In one embodiment, the I-line may only be placed in the I-cache 222 where changes have been made to information stored in the I-line.

According to one embodiment of the invention, when a modified I-line is written back into the L2 cache 112, the I-line may be marked as changed. Where an I-line is written back to the I-cache 222 and marked as changed, the I-line may remain in the I-cache for differing amounts of time. For example, if the I-line is being used frequently by the processor core 114, the I-line may fetched and returned to the I-cache 222 several times, possibly be updated each time. If, however, the I-line is not frequently used (referred to as aging), the I-line may be purged from the I-cache 222. When the I-line is purged from the I-cache 222, the I-line may be written back into the L2 cache 112. In one embodiment, the I-line may only be written back to the L2 cache where the I-line is marked as being modified. In another embodiment, the I-line may always be written back to the L2 cache 112. In one embodiment, the I-line may optionally be written back to several cache levels at once (e.g., to the L2 cache 112 and the I-cache 222) or to a level other than the I-cache 222 (e.g., directly to the L2 cache 112).

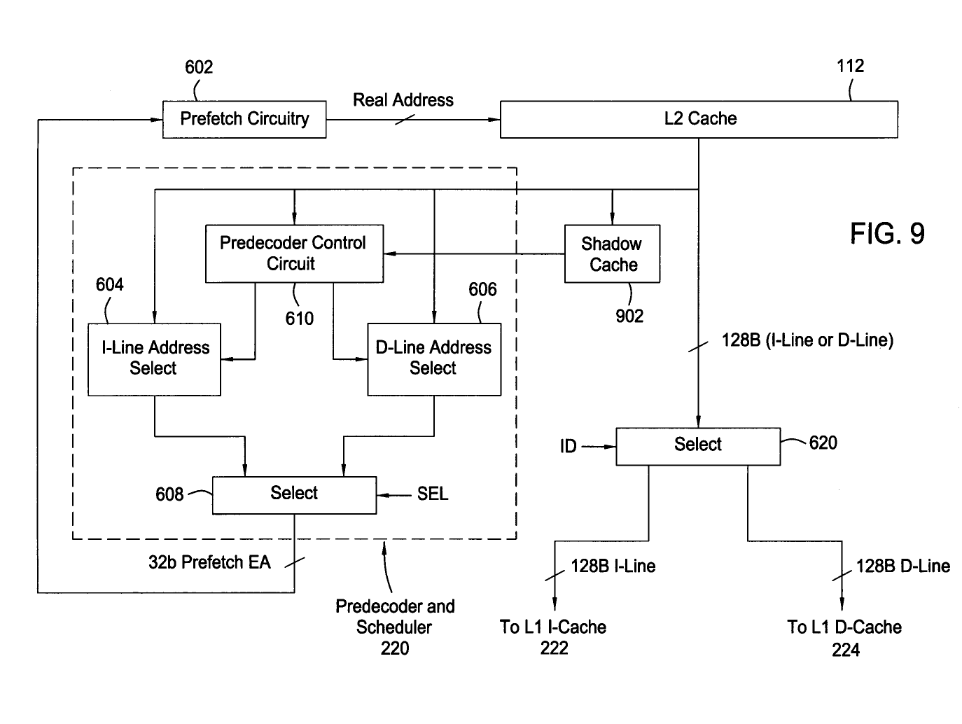

In one embodiment of the invention, data target address(es) may be stored in a location other than an I-line. For example, the data target addresses may be stored in a shadow cache. FIG. 9 is a block diagram depicting a shadow cache 902 for prefetching instruction and D-lines according to one embodiment of the invention.

In one embodiment of the invention, when a data target address for a data access instruction in an I-line is to be stored (e.g., because the data access instruction is frequently executed or causes D-cache misses, and/or according to any of the criteria listed above), an address or a portion of an address corresponding to the I-line (e.g., the effective address of the I-line or the higher-order 32 bits of the effective address) as well as the data target address (or a portion thereof) may be stored as an entry in the shadow cache 902. In some cases, multiple data target address entries for a single I-line may be stored in the shadow cache 902. Optionally, each entry for an I-line may contain multiple data target addresses.

When information is fetched from the L2 cache 112, the shadow cache 902 (or other control circuitry using the shadow cache 902, e.g., the predecoder control circuitry 610) may determine if the fetched information is an I-line. If a determination is made output by the L2 cache 112 is an I-line, the shadow cache 902 may be searched (e.g., the shadow cache 902 may be content addressable) for an entry (or entries) corresponding to the fetched I-line (e.g., an entry with the same effective address as the fetched I-line). If a corresponding entry is found, the data target address(es) associated with the entry may be used by the predecoder control circuit 610, other circuitry in the predecoder and scheduler 220, and prefetch circuitry 602 to prefetch the data target address(es) indicated by the shadow cache 902. Optionally, branch exit addresses may be stored in the shadow cache 902 (either exclusively or with data target addresses). As described above, the shadow cache 902 may, in some cases, be used to fetch a chain/group of I-lines and D-lines using effective addresses stored therein and/or effective addresses stored in the fetched and prefetched I-lines.

In one embodiment of the invention, the shadow cache 902 may also store control bits (e.g., history and location bits) described above. Optionally, such control bits may be stored in the I-line as described above. In either case, in one embodiment, entries in the shadow cache 902 may be managed according any of the principles enumerated above with respect to determining which entries are to be stored in an I-line. As an example (of the many techniques described above, each of which may be implemented with the shadow cache 902), data target addresses for data access instructions which cause strongly predicted D-cache misses may be stored in the shadow cache 902, whereas data target addresses corresponding to weakly predicted D-cache misses may be overwritten.

In addition to using the techniques described above to determine which entries to store in the shadow cache 902, in one embodiment, traditional cache management techniques may be used to manage the shadow cache 902, either exclusively or including the techniques described above. For example, entries in the shadow cache 902 may have age bits which indicate the frequency with which entries in the shadow cache 902 are accessed. If a given entry is frequently accessed, the age value may remain small (e.g., young). If, however, the entry is infrequently accessed, the age value may increase, and the entry may in some cases be discarded from the shadow cache 902.

### CONCLUSION

As described, addresses of data targeted by data access instructions contained in a first I-line may be stored and used to prefetch, from an L2 cache, D-lines containing the targeted data. As a result, the number of D-cache misses and corresponding latency of accessing data may be reduced, leading to an increase in processor performance.

While the foregoing is directed to embodiments of the present invention, other and further embodiments of the invention may be devised without departing from the basic scope thereof, and the scope thereof is determined by the claims that follow.

What is claimed is:

1. A method of prefetching data lines, comprising:
(a) fetching a first instruction line from a level 2 cache;
(b) extracting, from the first instruction line, an address identifying a first data line containing data targeted by a data access instruction contained in the first instruction line or a different instruction line; and
(c) prefetching, from the level 2 cache, the first data line using the extracted address.

2. The method of claim 1, further comprising:
identifying, in the first instruction line, a branch instruction targeting an instruction that is outside of the first instruction line;
extracting an exit address corresponding to the identified branch instruction; and
prefetching, from the level 2 cache, a second instruction line containing the targeted instruction using the extracted exit address.

3. The method of claim 2, further comprising:
repeating steps (a) to (c) for the second instruction line to prefetch a second data line containing second data targeted by a second data access instruction.

4. The method of claim 3, wherein the second data access instruction is in the second instruction line.

5. The method of claim 3, wherein the second data access instruction is in the first instruction line.

6. The method of claim 1, further comprising:
repeating steps (a) to (c) until a threshold number of data lines are prefetched.

7. The method of claim 1, further comprising:
identifying, in the first instruction line, a second data access instruction targeting second data;
extracting a second address from the identified second data access instruction; and
prefetching, from the level 2 cache, a second data line containing the targeted second data using the extracted second address.

8. The method of claim 1, wherein the extracted address is stored as an effective address contained in an instruction line.

9. The method of claim 8, wherein the instruction line is the first instruction line.

10. The method of claim 8, wherein the effective address is calculated during a previous execution of the identified branch instruction.

11. The method of claim 1, wherein the first instruction line contains two or more data access instructions targeting two or more data, and wherein a data access history value stored in the first instruction line indicates that the identified data access instruction is predicted to cause a cache miss.

12. The method of claim 1, further comprising:
identifying, in the first instruction line, a data access instruction targeting first data.

13. A processor comprising:
a level 2 cache;
a level 1 cache configured to receive instruction lines from the level 2 cache, wherein each instruction line comprises one or more instructions;
a processor core configured to execute instructions retrieved from the level 1 cache; and
circuitry configured to:
(a) fetch a first instruction line from a level 2 cache;
(b) identify, in the first instruction line, an address identifying a first data line containing data targeted by a data access instruction contained in the first instruction line or a different instruction line; and
(c) prefetch, from the level 2 cache, the first data line using the extracted address.

14. The processor of claim 13, wherein the control circuitry is further configured to:
identify, in the first instruction line, a branch instruction targeting an instruction that is outside of the first instruction line;
extract an exit address corresponding to the identified branch instruction; and
prefetch, from the level 2 cache, a second instruction line containing the targeted instruction using the extracted exit address.

15. The processor of claim 14, wherein the control circuitry is further configured to:
repeat steps (a) to (c) for the second instruction line to prefetch a second data line containing second data targeted by a second data access instruction.

16. The processor of claim 15, wherein the second data access instruction is in the second instruction line.

17. The processor of claim 15, wherein the second data access instruction is in the first instruction line.

18. The processor of claim 14, wherein the control circuitry is further configured to:
repeat steps (a) to (c) until a threshold number of data lines are prefetched.

19. The processor of claim 14, wherein the control circuitry is further configured to:
identify, in the first instruction line, a second data access instruction targeting second data;
extract a second address from the identified second data access instruction; and
prefetch, from the level 2 cache, a second data line containing the targeted second data using the extracted second address.

20. The processor of claim 13, wherein the extracted address is stored as an effective address contained in an instruction line.

21. The processor of claim 20, wherein the instruction line is the first instruction line.

22. The processor of claim 20, wherein the effective address is calculated during a previous execution of the identified branch instruction.

23. The processor of claim 22, wherein the effective address is calculated during a training phase.

24. The processor of claim 13, wherein the first instruction line contains two or more data access instructions targeting two or more data, and wherein a data access history value stored in the first instruction line indicates that the identified data access instruction is predicted to cause a cache miss.

25. A method of storing data target addresses in an instruction line, the method comprising:
executing one or more instructions in the instruction line;
determining if the one or more instructions accesses data in a data line and results in a cache miss; and
if so, storing a data target address corresponding to the data line in a location which is accessible by a prefetch mechanism.

26. The method of claim 25, wherein the location is the instruction line.

27. The method of claim 26, further comprising:
writing the instruction line with the target data address back to a level 2 cache.

28. The method of claim 26, further comprising:
storing the instruction line with data target address in a level two cache;
fetching the instruction line with data target address from the level two cache and placing the instruction line in a level one cache; and
prefetching the data line using the stored data target address.

29. The method of claim 25, wherein the location is a shadow cache.

30. The method of claim 25, further comprising:
storing data access history information corresponding to the one or more instructions in the location.

31. The method of claim 30, further comprising:
during a subsequent execution of the one or more instructions in the instruction line, executing one or more second instructions in the instruction line;
if the one or more second instructions accesses data in a second data line, wherein the access results in a second cache miss, determining if the data access history information corresponding to the one or more instructions indicates that the cache miss is predictable;
if the cache miss is not predictable, appending a second data target address to the instruction line corresponding to the second data line.

32. The method of claim 25, wherein storing the data access address is performed during an initial execution phase in which a number of instruction lines are executed repeatedly.

33. The method of claim 25, further comprising:
executing a one or more second instructions in the instruction line;
determining if the one or more second instructions branches to an instruction in another instruction line; and
if so, storing an exit address corresponding to the other instruction line in the location.

34. The method of claim 25, wherein the data access address is an effective address is calculated during the execution of the one of one or more of the instructions.
